(19) United States
(12) Patent Application Publication
(10) Pub. No.: US 2010/0172248 A1
(43) Pub. Date: Jul. 8, 2010

(54) COMMUNICATION SYSTEM, SUPERVISORY/CONTROL METHOD, AND REPEATING APPARATUS AND PROGRAM

(76) Inventor: KEN SHIRAISHI, Tokyo (JP)

Correspondence Address: Mr. Jackson Chen, 6535 N. STATE HWY 161, IRVING, TX, 75039, US

(21) Appl. No.: 12/406,526

(22) Filed: Mar. 18, 2009

(30) Foreign Application Priority Data
Mar. 24, 2008 (JP) 2008-075513

(51) Int. Cl. H04L 12/26

(52) U.S. Cl. 370/247

(57) ABSTRACT

A repeating apparatus to which a supervisory/control apparatus is connected inserts a supervisory/control signal for use by the supervisory/control apparatus to supervise or control the repeating apparatus to which the supervisory/control apparatus is not connected into an unused area within a transmission frame, and a supervisory/control unit of the repeating apparatus to which the supervisory/control apparatus is not connected extracts the supervisory/control signal from the transmission frame and outputs the extracted signal to the supervisory/control apparatus. The repeating apparatus to which the supervisory/control apparatus is not connected extracts a supervisory/control signal from a transmission frame, gives the extracted signal to the supervisory/control unit within own repeating apparatus, inserts the supervisory/control signal from the supervisory/control unit into an unused area within a transmission frame and transmits the resultant signal to the repeating apparatus to which the supervisory/control apparatus is connected.

### INCORPORATION BY REFERENCE

This application is based upon and claims the benefit of priority from Japanese patent application No. 2008-075513, filed on Mar. 24, 2008, the disclosure of which is incorporated herein in its entirety by reference.

### TECHNICAL FIELD

The present invention relates to a communication system, a supervisory/control method, and a repeating apparatus and program.

### BACKGROUND ART

Among a variety of communication systems, well known is a system which comprises a plurality of repeating apparatuses and a supervisory/control apparatus to supervise or control these repeating apparatuses, wherein each of these repeating apparatuses further comprises a supervisory/control function part which performs supervision or control over the function block within own repeating apparatus based on supervisory/control signals transmitted and received to and from the supervisory/control apparatus.

Examples of related art concerning such a communication system can be found in, for example, Patent Literature 1. As an example of this type of communication system, an example configuration of a Gigabit Ethernet MUX (MUltipleXer) apparatus is shown in FIG. 7. This is a configuration diagram for an existing Gigabit Ethernet MUX apparatus. As shown in FIG. 7, the supervisory/control function parts 2-1, 2-2 of repeating apparatuses 60-1, 60-2 communicate with a supervisory/control apparatus 4 via a supervision/control-dedicated network 3, which is provided separately from a main signal network.

Patent Literature 1: Japanese Patent Laying-Open No. 2005-269507

In the configuration shown in FIG. 7, supervision or control of the repeating apparatuses 60-1, 60-2 is not possible unless the supervisory/control function parts 2-1, 2-2 of both the repeating apparatus 60-1, 60-2 are respectively connected to the supervision/control-dedicated network 3. This presents a problem of increased complexity in the building and management of a supervision/control-dedicated network.

While the example of FIG. 7 shows a configuration with only two repeating apparatuses, it is common in practice that a greater number of repeating apparatuses are used. When many repeating apparatuses are used, all of the repeating apparatuses must respectively be connected to the supervisory/control apparatus 4 via the supervision/control-dedicated network 3, resulting in greater complexity encountered when building and managing such a network.

### OBJECTS OF INVENTION

The present invention has been made to solve the above-described problem, and its object is thus to provide a communication system, a supervisory/control method, and a repeating apparatus and program which can simplify the building of a supervision/control-dedicated network.

### SUMMARY

The present invention is a communication system which comprises a plurality of repeating apparatuses and a supervisory/control apparatus to supervise or control these repeating apparatuses, wherein each of these repeating apparatuses further comprises a supervisory/control unit which performs supervision or control over the function block within own repeating apparatus based on supervisory/control signals transmitted and received to and from the supervisory/control apparatus.

A first exemplary aspect of the invention, a communication system, includes a plurality of repeating apparatuses and a supervisory/control apparatus which supervises or controls the plurality of repeating apparatuses, wherein

the repeating apparatuses each comprises a supervisory/control unit which performs supervisory or control within own apparatus based on a supervisory/control signal from the supervisory/control apparatus,

the supervisory/control apparatus is connected to any one of the plurality of repeating apparatuses;

the repeating apparatus connected to the supervisory/control apparatus includes

a first insertion unit which inserts a supervisory/control signal intended for other repeating apparatuses not connected to the supervisory/control apparatus into a transmission frame to be transmitted to the other repeating apparatuses, and

a first extraction unit which extracts the supervisory/control signal from a transmission frame received from other repeating apparatuses not connected to the supervisory/control apparatus, and outputs the extracted supervisory/control signal to the supervisory/control apparatus; and

each of other repeating apparatuses not connected to the supervisory/control apparatus includes

a second extraction unit which extracts the supervisory/control signal inserted into a received transmission frame and outputs the signal to the supervisory/control unit of own repeating apparatus, and

a second insertion unit which inserts a supervisory/control signal from the supervisory/control unit of own apparatus into the transmission frame to be transmitted to the repeating apparatus connected to the supervisory/control apparatus.

A second exemplary aspect of the invention, a supervisory/control method for a communication system which includes a plurality of repeating apparatuses and a supervisory/control apparatus that supervises or controls the plurality of repeating apparatuses, wherein

the supervisory/control apparatus is connected to any one of the plurality of repeating apparatuses;

the repeating apparatus connected to the supervisory/control apparatus includes the steps of:

inserting a supervisory/control signal intended for other repeating apparatuses not connected to the supervisory/control apparatus into a transmission frame to be transmitted to the other repeating apparatuses; and

extracting the supervisory/control signal from a transmission frame received from other repeating apparatuses not connected to the supervisory/control apparatus, and outputting the extracted supervisory/control signal to the supervisory/control apparatus; and

each of other repeating apparatuses not connected to the supervisory/control apparatus includes the steps of:

extracting the supervisory/control signal inserted into a received transmission frame and outputting the signal to the supervisory/control unit of own repeating apparatus; and

inserting a supervisory/control signal from the supervisory/control unit of own apparatus into the transmission frame to be transmitted to the repeating apparatus connected to the supervisory/control apparatus.

A third exemplary aspect of the invention, a repeating apparatus which comprises a supervisory/control unit that performs supervisory or control within own apparatus based on a supervisory/control signal from a supervisory/control apparatus which supervises or controls over a plurality of repeating apparatuses,

being connected to the supervisory/control apparatus, and including

an insertion unit which inserts a supervisory/control signal intended for other repeating apparatuses not connected to the supervisory/control apparatus into a transmission frame to be transmitted to the other repeating apparatuses; and

an extraction unit which extracts the supervisory/control signal from a transmission frame received from other repeating apparatuses not connected to the supervisory/control apparatus, and outputs the extracted supervisory/control signal to the supervisory/control apparatus.

A fourth exemplary aspect of the invention, a computer readable medium storing a program which operates on a repeating apparatus which comprises a supervisory/control unit that performs supervisory or control within own apparatus based on a supervisory/control signal from a supervisory/control apparatus which supervises or controls over a plurality of repeating apparatuses, wherein

the program causes the repeating apparatus connected to the supervisory/control apparatus to execute

an insertion function which inserts a supervisory/control signal intended for other repeating apparatuses not connected to the supervisory/control apparatus into a transmission frame to be transmitted to the other repeating apparatuses; and

an extraction function which extracts the supervisory/control signal from a transmission frame received from other repeating apparatuses not connected to the supervisory/control apparatus, and outputs the extracted supervisory/control signal to the supervisory/control apparatus.

According to the present invention, the building of a supervision/control-dedicated network can be simplified.

### BRIEF DESCRIPTION OF THE DRAWINGS

FIG. 1 is a conceptual diagram for a communication system according to a first exemplary embodiment of the present invention;

FIG. 2 is a configuration diagram for a repeating apparatus according to the first exemplary embodiment of the present invention;

FIG. 3 is a block diagram for the Insert/Drop function part of the repeating apparatus according to the first exemplary embodiment of the present invention;

FIG. 4 is a diagram which illustrates the operation procedure for the repeating apparatus according to the first exemplary embodiment of the present invention;

FIG. 5 is a diagram which shows a state wherein a supervisory/control signal is inserted into the IFG signal section according to the first exemplary embodiment of the present invention;

FIG. 6 is a diagram which shows a control signal communication channel of the supervisory/control function part within the repeating apparatus according to the first exemplary embodiment of the present invention; and

FIG. 7 is a configuration diagram for an existing Gigabit Ethernet MUX apparatus.

### EXEMPLARY EMBODIMENT

Exemplary embodiments of the present invention will now be described in detail with reference to the drawings.

### First Exemplary Embodiment

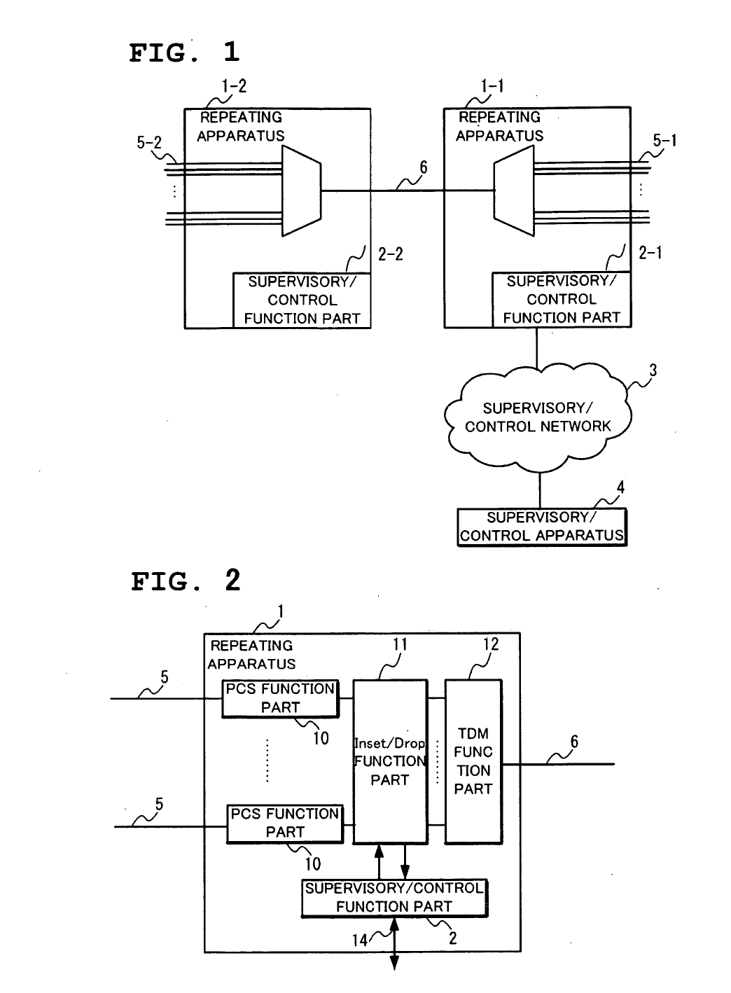

A communication system according to a first exemplary embodiment of the invention will be described with reference to FIGS. 1 to 6.

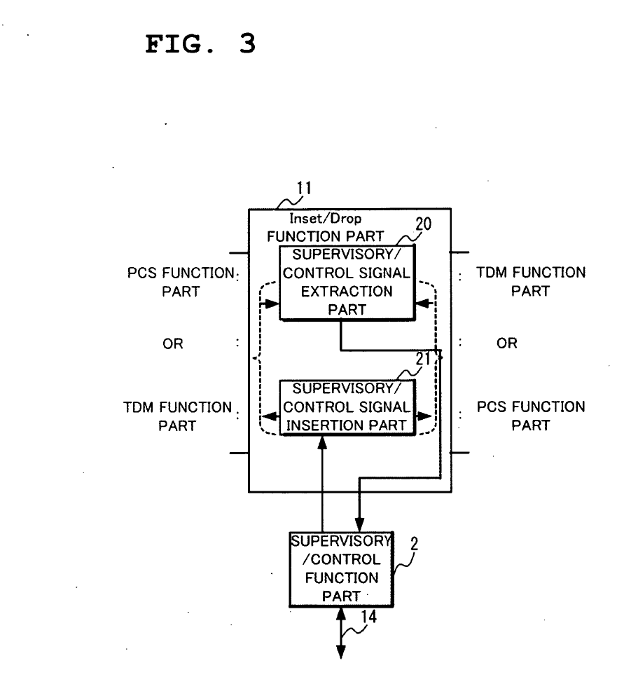

FIG. 1 is a conceptual diagram for a communication system according to a first exemplary embodiment of the present invention. FIG. 2 is a block diagram which shows an example configuration of a repeating apparatus according to the first exemplary embodiment of the present invention. FIG. 3 is a block diagram which shows an example configuration of an Insert/Drop function part according to the first exemplary embodiment of the present invention.

As shown in FIG. 1, the communication system according to the first exemplary embodiment of the present invention comprises a plurality of repeating apparatuses 1-1, 1-2 and a supervisory/control apparatus 4 to supervise or control these repeating apparatuses 1-1, 1-2.

Each of the repeating apparatuses 1-1, 1-2 comprises a supervisory/control function part 2-1, 2-2 to perform supervisory or control over the function block within own repeating apparatus, based on supervisory/control signals transmitted and received to and from the supervisory/control apparatus 4.

The characteristics of the first exemplary embodiment of the present invention are as follows.

Firstly, of the two repeating apparatuses 1-1, 1-2, the repeating apparatus 1-1 has the supervisory/control apparatus 4 connected thereto via a supervision/control-dedicated network 3, as shown in FIGS. 2 and 3.

Secondly, the repeating apparatus 1-1 comprises a supervisory control signal insertion part 21, which, when the supervisory/control apparatus 4 supervises or controls the repeating apparatus 1-2 to which the supervisory/control apparatus 4 is not connected, inserts a supervisory/control signal to supervise or control the repeating apparatus 1-2 into an unused area (idle signal segment) within a transmission frame transmitted and received between the repeating apparatus 1-1 and the repeating apparatus 1-2, and a supervisory/control signal extraction part 20 which extracts the supervisory/control signal inserted by the supervisory/control function part 2-2 of the repeating apparatus 1-2 into an unused area of a transmission frame from such transmission frame and outputs the extracted signal to the supervisory/control apparatus 4.

Thirdly, the repeating apparatus 1-2 comprises a supervisory control signal extraction part 20, which extracts a supervisory/control signal inserted into an unused area of a transmission frame and transmits the extracted signal to the supervisory/control function part 2-2 of own repeating apparatus, and a supervisory/control signal insertion part 21, which inserts the supervisory/control signal acquired by the supervisory/control function part 2-2 into an unused area of a transmission frame and transmits the inserted signal to the repeating apparatus 1-1 to which the supervisory/control apparatus 4 is connected.

It should be noted that the contents of processing of a supervisory/control signal differ between the supervisory/control signal extraction part 20/the supervisory/control signal insertion part 21 of the repeating apparatus 1-1 and the supervisory/control signal extraction part 20/the supervisory/control signal insertion part 21 of the repeating apparatus 1-2. However, it is desirable that the two supervisory/control signal extraction parts 20 and the two supervisory/control signal insertion parts 21 have the same functions, respectively, so that they can be used interchangeably when a configuration in which the repeating apparatus 1-2 is connected to the supervisory/control apparatus 4 becomes necessary.

The communication system according to the first exemplary embodiment will be described below.

The communication system according to the first exemplary embodiment of the present invention can realize remote supervision and control between repeating apparatuses, such as WDM (Wavelength Division Multiplexing) apparatuses for Ethernet and Ethernet MUX apparatuses, by use of a control-dedicated communication network built in a simplified manner and without deteriorating the band for main signals.

The communication system shown in FIG. 1 is an example of application to a Gigabit Ethernet MUX system. FIG. 1 shows an example configuration which performs supervisory and control of the repeating apparatus 1-2 by connecting the supervisory/control apparatus 4 to the repeating apparatus 1-1. By connecting the supervisory/control apparatus 4 to the repeating apparatus 1-1 side, it becomes possible for the repeating apparatus 1-1 side to perform supervisory and control of the repeating apparatus 1-2.

The repeating apparatus 1-1, 1-2 of FIG. 1 performs communication via a transmission line 6 after performing TDM (Time Division Multiplexing) on Ethernet lines 5-1, 5-2, which transmit Ethernet data.

A supervisory/control signal between the repeating apparatus 1-1 and the repeating apparatus 1-2 is inserted into an idle segment (section) of Ethernet data or is extracted from the idle segment of Ethernet data. By this, it becomes possible for the supervisory/control apparatus 4 connected to the repeating apparatus 1-1 side via a supervision/control-dedicated network 3 to perform supervisory and control over the repeating apparatus 1-2 by using the supervisory/control function part 2-1 on the repeating apparatus 1-1 side.

The supervisory/control function part 2-1 of the repeating apparatus 1-1 communicates with the supervisory/control apparatus 4 via the control/supervisory-dedicated network 3.

By using the above-described configuration, the necessity to build a network to supervise and control the repeating apparatus 1-2 is eliminated. In addition, inserting a supervisory/control signal into an idle segment within Ethernet data makes it possible to prevent the band for transmission data from deteriorating. Moreover, by controlling or supervising two opposed repeating apparatuses as a single system, efforts required for network management can be reduced.

FIG. 2 shows a configuration of the repeating apparatus 1 used in a Gigabit Ethernet MUX system. The repeating apparatus 1 comprises a PCS (Physical Coding Sub-layer) function part 10, which terminates transmission data received through an Ethernet line 5; an Insert/Drop function part 11, which performs an Insert/Drop process on a supervisory/control signal; a TDM function part 12, which multiplexes a gigabit Ethernet into TDM signals; and a supervisory/control function part 2, which performs supervisory and control.

### Operation of the First Exemplary Embodiment

The processing procedure for transmission data directed from the Ethernet line 5 to the transmission line 6 will be described below.

Upon receipt of transmission data from the Ethernet line 5, the PCS function part 10 performs a termination process on the received transmission data. The supervisory/control signal insertion part 21 of the Insert/Drop function part 11 inserts a supervisory/control signal to be transmitted from the supervisory/control function part 2 to the opposed repeating apparatus, into an idle section (i.e., unused area) within Ethernet data (i.e., the transmission data terminated by the PCS function part 10), and transmits the Ethernet data to the TDM function part 12.

The TDM function part 12 maps the gigabit Ethernet data received from the Insert/Drop function part 11, including the idle section, to an OC192 frame, and transmits it to the opposed repeating apparatus as the transmission data (TDM-multiplexed data) via the transmission line 6.

Next, the processing procedure for transmission data directed from the transmission line 6 to the Ethernet line 5 will be described.

Upon receipt of the transmission data (TDM-multiplexed data) from the opposed repeating apparatus via the transmission line 6, the TDM function part 12 of the repeating apparatus divides the received transmission data, including the idle signal, to allocate among the ports.

From the data divided to allocate among the ports, the supervisory/control signal extraction part 20 of the Insert/Drop function part 11 extracts the supervisory/control signal, which is inserted into such transmission data, from the supervisory/control function part 2 of the opposed apparatus, or the supervisory/control signal from the supervisory/control apparatus 4.

Following this, the idle signal within the transmission data is converted into a normal idle signal and inputted into the PCS function part 10. The PCS function part 10 transmits the transmission data to the Ethernet line 5 as gigabit Ethernet data.

In the case of the repeating apparatus not connected to the supervisory/control apparatus 4, the opposed apparatus' supervisory/control signal extracted by the supervisory/control signal extraction part 20 of the Insert/Drop function part 11 is transmitted to the supervisory/control function part 2 within own apparatus; in the case of the repeating apparatus connected to the supervisory/control apparatus 4, the signal is transmitted to the supervisory/control apparatus 4.

The supervisory/control function part 2 performs a predetermined supervisory/control based on the received supervisory/control signal.

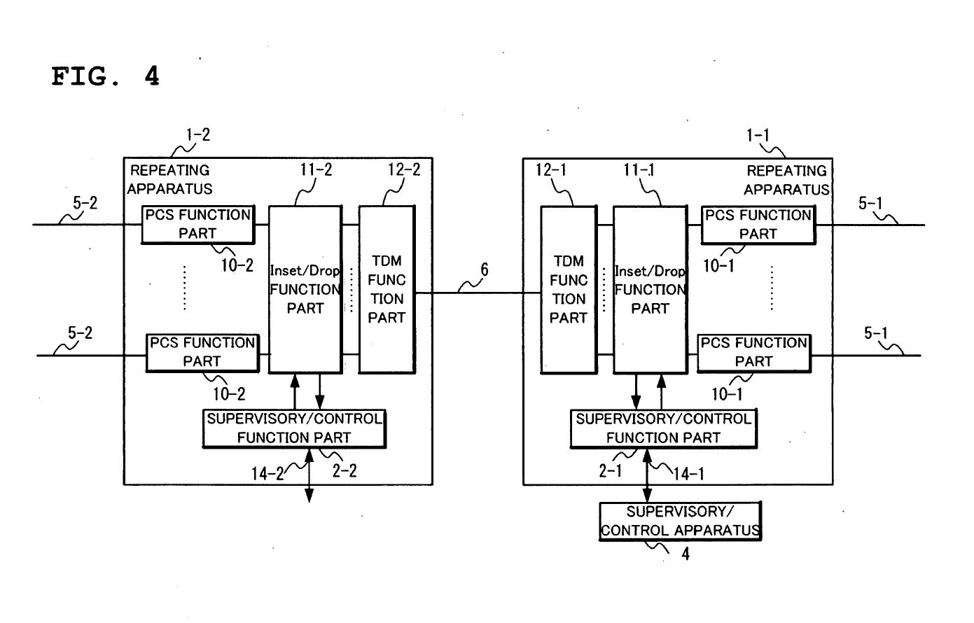

Next, the operation procedure for the repeating apparatus will be described with reference to FIGS. 4 to 6.

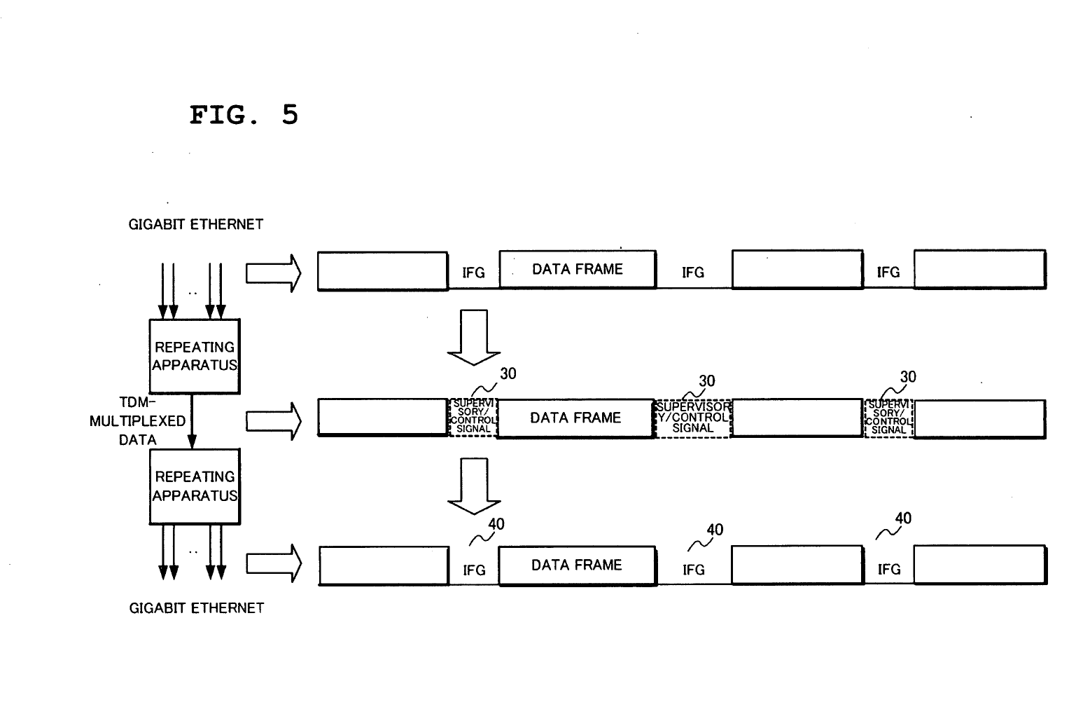

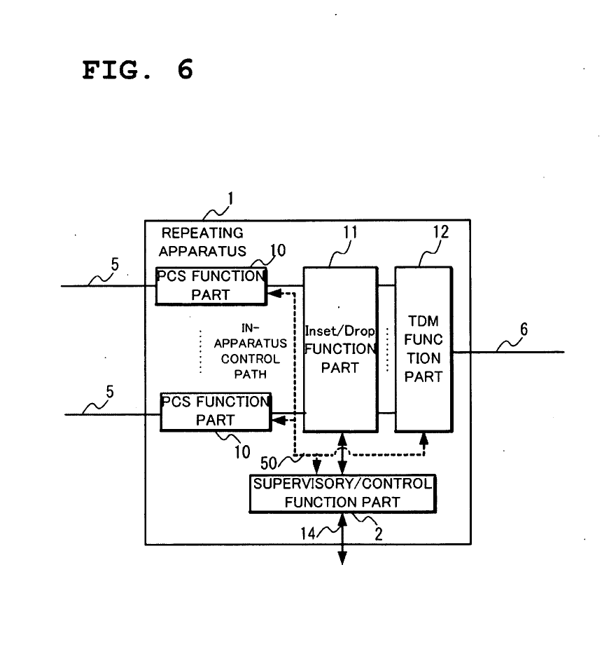

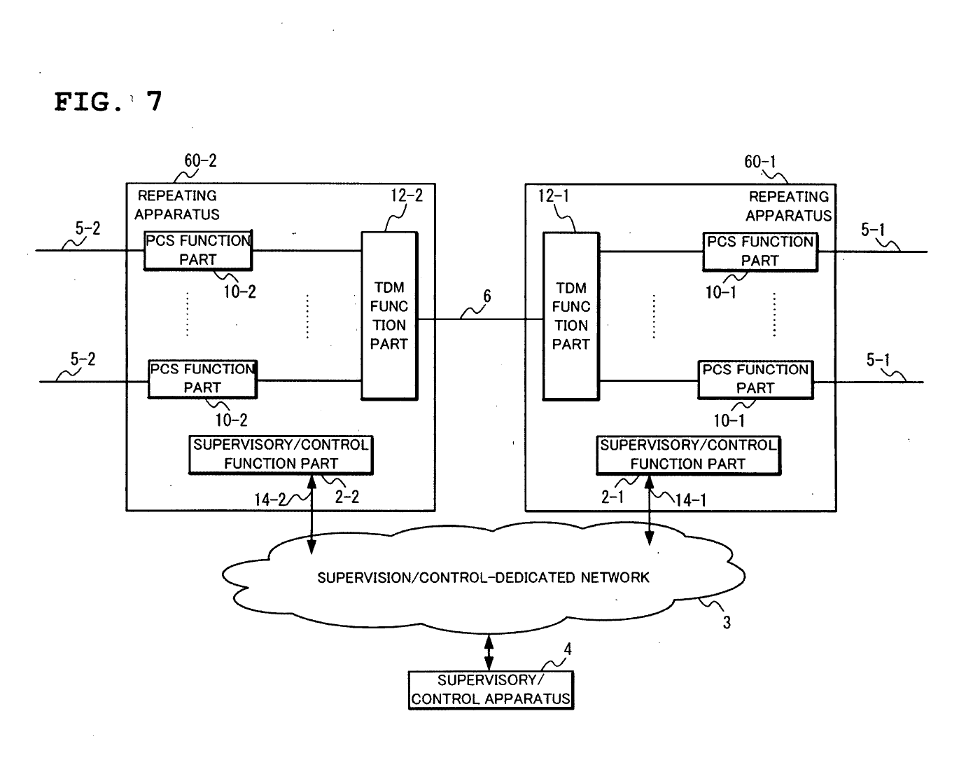

FIG. 4 is a diagram illustrating the operation procedure for the repeating apparatus. FIG. 5 is a diagram which shows a state wherein a supervisory/control signal is inserted into the IFG (Inter Frame Gap) signal section. FIG. 6 is a diagram which shows a control signal communication channel of the supervisory/control function part within the repeating apparatus.

The operation of the repeating apparatus 1-2 will first be described.

As shown in FIG. 4, the PCS function part 10-2 of the repeating apparatus 1-2 terminates the transmission data from the Ethernet line 5-2, performs the 8B/10B decoding, and transmits the resultant data to the Insert/Drop function part 11-2.

The supervisory/control signal insertion part 21 of the Insert/Drop function part 11-2 receives a supervisory/control signal to be transmitted to the supervisory/control apparatus 4 from the supervisory/control function part 2-2 in a frame form, and, as shown in FIG. 5, divides and inserts the supervisory/control signal 30 into the IFG signal section 40 (IFG in FIG. 5), which is an idle section within the transmission data received from the PCS function part 10-2, and then outputs the resultant data to the TDM function part 12-2.

In addition, the supervisory/control signal extraction part 20 of the Insert/Drop function part 11-2 extracts the supervisory/control signal 30 from the transmission data received from the TDM function part 12-2, rebuilds the extracted supervisory/control signal, and outputs the resultant signal to the supervisory/control function part 2-2. When extracting the supervisory/control signal 30, the supervisory/control signal extraction part 20 of the Insert/Drop function part 11-2 inserts the IFG signal section 40 within the gigabit Ethernet data into the transmission data, and outputs the resultant data to the PCS function part 10-2.

From the supervisory/control signal extraction part 20 of the Insert/Drop function part 11-2, the supervisory/control function part 2-2 receives the supervisory/control extracted from the transmission data signal, and performs supervisory or control over the inside of the repeating apparatus 1-1 (more specifically, by making settings, responding with read-out values, etc.), based on the received supervisory/control signal, by use of the in-apparatus control path 50 (refer to FIG. 6).

In addition, the supervisory/control function part 2-2 outputs the result obtained from the supervisory or control process, in a frame form, to the supervisory/control signal insertion part 21 of the Insert/Drop function part 11-2, as a supervisory/control signal to be transmitted to the opposed apparatus.

The TDM function part 12-2 maps the transmission data received from the Insert/Drop function part 11-2, including the supervisory/control signal, to the OC192 frame, multiplexes it into, for example, 10 Gbps, and transmits the. resultant data to the transmission line 6 as the gigabit Ethernet data.

Next, the operation of the repeating apparatus 1-1 opposed to the repeating apparatus 1-2 will be described.

The repeating apparatus 1-1 uses the TDM function part 12-1 to receive the gigabit Ethernet data in the OC192 frame transmitted from the repeating apparatus 1-2 via the transmission line 6. The TDM function part 12-1 allocates the received gigabit Ethernet data, including the supervisory/control signal 30, among the ports, and outputs the resultant data to the Insert/Drop function part 11-1.

The supervisory/control function part 2-1 of the repeating apparatus 1-1 performs supervisory or control over the inside of the repeating apparatus 1-1 (more specifically, by making settings, responding with read-out values, etc.), based on the supervisory/control signal from the supervisory/control apparatus 4, by use of the in-apparatus control path 50 (refer to FIG. 6). The supervisory/control function part 2-1 then transmits the result obtained from the supervisory or control process to the supervisory/control apparatus 4 as the supervisory/control signal.

The supervisory/control signal extraction part 20 of the Insert/Drop function part 11-1 extracts the supervisory/control signal, which was obtained by the repeating apparatus 1-2, from the transmission data received from the TDM function part 12-1, and rebuilds the extracted supervisory/control signal. The supervisory/control signal extraction part 20 outputs the resultant signal to the supervisory/control function part 2-1. The supervisory/control function part 2-1 then transmits the received supervisory/control signal to the supervisory/control apparatus 4.

In addition, the supervisory/control function part 2-1 inserts the IFG signal section 40, which is an idle signal within the gigabit Ethernet, into the idle section, from which the supervisory/control signal was extracted, within the transmission data received from the TDM function part 12-1, and outputs the resultant data to the PCS function part 10-1.

Furthermore, the supervisory/control signal insertion part 21 receives the supervisory/control signal intended for the repeating apparatus 1-2 from the supervisory/control apparatus 4, divides the received supervisory/control signal intended for the repeating apparatus 1-2 into smaller pieces, inserts them into the idle section within the transmission data received from the PCS function part 10-1, and outputs the resultant data to the TDM function part 12-1.

The PCS function part 10-1 outputs the signal received from the Insert/Drop function part 11-1 to the Ethernet line 5-1 as the gigabit Ethernet signal.

The supervisory/control function part 2-1 of the repeating apparatus 1-1 performs communication with the supervisory/control apparatus 4 via the control-dedicated transmission line 14. By using the method described above, the supervisory/control apparatus 4 can perform supervisory and control over both the repeating apparatus 1-1 and the repeating apparatus 1-2.

Exemplary embodiments of the present invention are not limited to the configuration described above, but can also be applied to an apparatus incorporated into a repeating apparatus which multiplexes Ethernet, to transmit and receive control data by using an idle section of an Ethernet signal.

### Effects of the First Exemplary Embodiment

According to the first exemplary embodiment described above, the following effects can be obtained.

Firstly, a supervision/control-dedicated network 3 can be simplified because two repeating apparatuses 1-1, 1-2 can be supervised or controlled via one supervisory/control apparatus 4 and thus it suffices to build a supervision/control-dedicated network 3 to work with only one repeating apparatus 1-1.

Secondly, the necessity to continuously set a signal line specifically for supervisory/control signals can be eliminated by inserting a supervisory/control signal into an idle section within a main signal. In addition, by transmitting and receiving a supervisory/control signal using an idle section of a main signal, it becomes possible to perform mutual supervise or control between the repeating apparatuses without causing deterioration of main signals.

Thirdly, network management becomes easier because two repeating apparatuses are supervised or controlled as a single system.

The functions of repeating apparatuses 1-1, 1-2 can be realized as software by causing an information processing apparatus to execute a program which provides the functions of the repeating apparatuses 1-1, 1-2 according to the above-described exemplary embodiment. The information processing apparatus above refers to a general-purpose computer apparatus.

The program which realizes the functions of the repeating apparatuses 1-1, 1-2 is stored in a storage medium which includes a ROM (Read Only Memory), a hard disc apparatus, etc., from which the program of this exemplary embodiment can be installed and executed by an information processing apparatus. Alternatively, the above-described program can be held on a server, and installed directly from the server onto an information processing apparatus via a network.

By this, the functions of the Insert/Drop function part 11 in the repeating apparatuses 1-1, 1-2 according to this exemplary embodiment can be realized by use of an information processing apparatus. In addition to the functions of the Insert/Drop function parts 11, the other functions may also be realized on an information processing apparatus, as long as they can be realized by means of a program.

A program which provides the functions of the repeating apparatuses 1-1, 1-2 include not only those which can be executed directly by an information processing apparatus, but also those which can be executed by installing in a hard disc or other similar means. The program includes those in compressed or encrypted form.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be utilized for the purpose of simplifying the building of a supervision/control-dedicated network.

What is claimed is:

1. A communication system, comprising a plurality of repeating apparatuses and a supervisory/control apparatus which supervises or controls said plurality of repeating apparatuses, wherein
said repeating apparatuses each comprises a supervisory/control unit which performs supervisory or control within own apparatus based on a supervisory/control signal from said supervisory/control apparatus;
said supervisory/control apparatus is connected to any one of said plurality of repeating apparatuses;
said repeating apparatus connected to said supervisory/control apparatus includes
a first insertion unit which inserts a supervisory/control signal intended for other repeating apparatuses not connected to said supervisory/control apparatus into a transmission frame to be transmitted to said other repeating apparatuses, and
a first extraction unit which extracts said supervisory/control signal from a transmission frame received from other repeating apparatuses not connected to said supervisory/control apparatus, and outputs the extracted supervisory/control signal to said supervisory/control apparatus; and
each of other repeating apparatuses not connected to said supervisory/control apparatus includes
a second extraction unit which extracts said supervisory/control signal inserted into a received transmission frame and outputs the signal to said supervisory/control unit of own repeating apparatus, and
a second insertion unit which inserts a supervisory/control signal from said supervisory/control unit of own apparatus into said transmission frame to be transmitted to said repeating apparatus connected to said supervisory/control apparatus.

2. The communication system according to claim 1, wherein each of said first and second insertion units
inserts said supervisory/control signal into an idle signal segment within said transmission frame; and
each of said first and second extraction units
extracts said supervisory/control signal inserted into the idle signal segment within said transmission frame.

3. The communication system according to claim 2, wherein each of said first and second insertion units divides said supervisory/control signal and inserts said divided supervisory/control signal into an idle signal segment within said transmission frame.

4. The communication system according to claim 2, wherein each of said first and second extraction units rebuilds said extracted supervisory/control signal, outputs the resultant signal to said supervisory/control apparatus or said supervisory/control unit, and inserts an idle signal into the idle signal segment within said transmission frame from which said supervisory/control signal has been extracted.

5. The communication system according to claim 1, wherein any one of said plurality of repeating apparatuses is connected to said supervisory/control apparatus via a supervision/control-dedicated network.

6. A supervisory/control method for a communication system which includes a plurality of repeating apparatuses and a supervisory/control apparatus that supervises or controls said plurality of repeating apparatuses, wherein
said supervisory/control apparatus is connected to any one of said plurality of repeating apparatuses;
said repeating apparatus connected to said supervisory/control apparatus includes the steps of:
inserting a supervisory/control signal intended for other repeating apparatuses not connected to said supervisory/control apparatus into a transmission frame to be transmitted to said other repeating apparatuses; and
extracting said supervisory/control signal from a transmission frame received from other repeating apparatuses not connected to said supervisory/control apparatus, and outputting the extracted supervisory/control signal to said supervisory/control apparatus; and
each of other repeating apparatuses not connected to said supervisory/control apparatus includes the steps of:
extracting said supervisory/control signal inserted into a received transmission frame and outputting the signal to said supervisory/control unit of own repeating apparatus; and
inserting a supervisory/control signal from said supervisory/control unit of own apparatus into said transmission frame to be transmitted to said repeating apparatus connected to said supervisory/control apparatus.

7. The supervisory/control method according to claim 6, wherein said step of inserting a supervisory/control signal
inserts said supervisory/control signal into an idle signal segment within said transmission frame; and
said step of extracting a supervisory/control signal
extracts said supervisory/control signal inserted into the idle signal segment within said transmission frame.

8. The supervisory/control method according to claim 7, wherein said step of inserting a supervisory/control signal divides said supervisory/control signal and inserts said divided supervisory/control signal into an idle signal segment within said transmission frame.

9. The supervisory/control method according to claim 7, wherein said step of extracting a supervisory/control signal rebuilds said extracted supervisory/control signal, outputs the resultant signal to said supervisory/control apparatus or said supervisory/control unit, and inserts an idle signal into the idle signal segment within said transmission frame from which said supervisory/control signal has been extracted.

10. The supervisory/control method according to claim 6, wherein any one of said plurality of repeating apparatuses is connected to said supervisory/control apparatus via a supervision/control-dedicated network.

11. A repeating apparatus which comprises a supervisory/control unit that performs supervisory or control within own apparatus based on a supervisory/control signal from a supervisory/control apparatus which supervises or controls over a plurality of repeating apparatuses, comprising:
being connected to said supervisory/control apparatus, and including
an insertion unit which inserts a supervisory/control signal intended for other repeating apparatuses not connected to said supervisory/control apparatus into a transmission frame to be transmitted to said other repeating apparatuses; and
an extraction unit which extracts said supervisory/control signal from a transmission frame received from other repeating apparatuses not connected to said supervisory/control apparatus, and outputs the extracted supervisory/control signal to said supervisory/control apparatus.

12. A repeating apparatus which comprises a supervisory/control unit that performs supervisory or control within own apparatus based on a supervisory/control signal from a supervisory/control apparatus which supervises or controls over a plurality of repeating apparatuses, comprising:
an extraction unit which extracts said supervisory/control signal inserted into a transmission frame received from a repeating apparatus connected to said supervisory/control apparatus, and outputs the extracted supervisory/control signal to said supervisory/control unit of own repeating apparatus; and
an insertion unit which inserts a supervisory/control signal from said supervisory/control unit of own apparatus into said transmission frame to be transmitted to said repeating apparatus connected to said supervisory/control apparatus.

13. The repeating apparatus according to claim 11, wherein said insertion unit
inserts said supervisory/control signal into an idle signal segment within said transmission frame; and
said extraction unit
extracts said supervisory/control signal inserted into the idle signal segment within said transmission frame.

14. The repeating apparatus according to claim 13, wherein said insertion unit divides said supervisory/control signal and inserts said divided supervisory/control signal into an idle signal segment within said transmission frame.

15. The repeating apparatus according to claim 13, wherein said extraction unit rebuilds said extracted supervisory/control signal, outputs the resultant signal to said supervisory/control apparatus or said supervisory/control unit, and inserts an idle signal into the idle signal segment within said transmission frame from which said supervisory/control signal has been extracted.

16. A computer readable medium storing a program which operates on a repeating apparatus which comprises a supervisory/control unit that performs supervisory or control within own apparatus based on a supervisory/control signal from a supervisory/control apparatus which supervises or controls over a plurality of repeating apparatuses, wherein
said program causes said repeating apparatus connected to said supervisory/control apparatus to execute
an insertion function which inserts a supervisory/control signal intended for other repeating apparatuses not connected to said supervisory/control apparatus into a transmission frame to be transmitted to said other repeating apparatuses; and
an extraction function which extracts said supervisory/control signal from a transmission frame received from other repeating apparatuses not connected to said supervisory/control apparatus, and outputs the extracted supervisory/control signal to said supervisory/control apparatus.

17. A computer readable medium storing a program which operates on a repeating apparatus which comprises a supervisory/control unit that performs supervisory or control within own apparatus based on a supervisory/control signal from a supervisory/control apparatus which supervises or controls over a plurality of repeating apparatuses, wherein
said program causes said repeating apparatus to execute
an extraction function which extracts said supervisory/control signal inserted into a transmission frame received from a repeating apparatus connected to said supervisory/control apparatus, and outputs the extracted supervisory/control signal to said supervisory/control unit of own repeating apparatus; and
an insertion function which inserts a supervisory/control signal from said supervisory/control unit of own apparatus into said transmission frame to be transmitted to said repeating apparatus connected to said supervisory/control apparatus.

18. The computer readable medium according to claim 16, wherein said insertion function
inserts said supervisory/control signal into an idle signal segment within said transmission frame; and
said extraction function
extracts said supervisory/control signal inserted into the idle signal segment within said transmission frame.

19. The computer readable medium according to claim 18, wherein said insertion function divides said supervisory/control signal and inserts said divided supervisory/control signal into an idle signal segment within said transmission frame.

20. The computer readable medium according to claim 18, wherein said extraction function rebuilds said extracted supervisory/control signal, outputs the resultant signal to said supervisory/control apparatus or said supervisory/control unit, and inserts an idle signal into the idle signal segment within said transmission frame from which said supervisory/control signal has been extracted.
